(19) United States
(12) Patent Application Publication
(10) Pub. No.: US 2005/0162489 A1
(43) Pub. Date: Jul. 28, 2005

(54) Inkjet printer ink cartridge

(76) Inventor: Alex Kuo-Shen Wang, Las Vegas, NV (US)

Correspondence Address: PRO-TECHTOR INTERNATIONAL, 20775 Norada Court, Saratoga, CA, 95070-3018, US

(21) Appl. No.: 10/767,159

(22) Filed: Jan. 28, 2004

(51) Int. Cl. B41J 2/175

(52) U.S. Cl. 347/86

(57) ABSTRACT

An inkjet printer ink cartridge, which improves upon the ink cartridge of a conventional inkjet ink cartridge, whereby need for sponge within the ink cartridge is eliminated, and a siphon device is configured within the ink cartridge. The ink cartridge utilizes a siphoning phenomenon to prevent leakage of ink from contact area of a nozzle of the inkjet printer and from an area of the siphon. Reusability of the ink cartridge is realized without affecting quality of printing of the ink cartridge, and without causing problems in environmental protection recovery.

### BACKGROUND OF THE INVENTION

(a) Field of the Invention

The present invention relates to an ink refill structure for an inkjet printer ink cartridge, and more particularly to the ink cartridge that eliminates need for any sponge to be used as material for the ink cartridge. The ink cartridge utilizes a siphoning phenomenon to realize reusability of the ink cartridge without affecting quality of printing of the ink cartridge, and without causing problems in.

(b) Description of the Prior Art

Referring to FIG. 1, which shows an ink cartridge 100 of a general inkjet printer having a sponge 200 packed within the ink cartridge 100, and wherewith capillarity of the sponge 200 is utilized to supply a steady and even quantity of ink to a nozzle of the printer. However, because of inability of the ink cartridge 100 to be reused, the ink cartridge 100 must be disposed of after the ink within is depleted. Even though a user can reluctantly re-inject ink into the ink cartridge 100, repeated injecting of ink will slowly cause deterioration of the sponge 200, and thus influence print quality of the ink cartridge 100, resulting in inability to reuse. As a consequence the Ink cartridges 100 are disposed of in considerable quantities, bringing about serious problems in environmental protection recovery.

### SUMMARY OF THE INVENTION

A primary objective of the present invention is to redesign a structure of an ink cartridge, whereby a siphon is configured within an ink receptacle of the ink cartridge, and utilizes a principle of a siphoning phenomenon. The ink cartridge thereby eliminates need for any sponge to be used as material for the ink cartridge, and achieves reusability of the ink cartridge without affecting quality of printing of the ink cartridge, and without causing problems in environmental protection recovery.

Another objective of the present invention is to utilize volume otherwise taken up by the sponge within the conventional ink cartridge and replace with ink, thus enabling even more ink to be filled within the ink cartridge, and thereby realizing the printing of an even greater number of sheets of paper from each usage of the ink cartridge.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a cross sectional schematic view of a conventional product.

FIG. 2 shows a general view according to the present invention.

FIG. 3 shows a cross sectional view according to the present invention.

FIG. 4 shows a general view of an embodiment according to the present invention.

FIG. 5 shows a cross sectional view of the embodiment according to the present invention.

FIG. 6 shows a cutaway view of FIG. 5 along A-A line according to the present invention.

FIG. 7 shows a cross sectional schematic view of ink refilling according to the present invention.

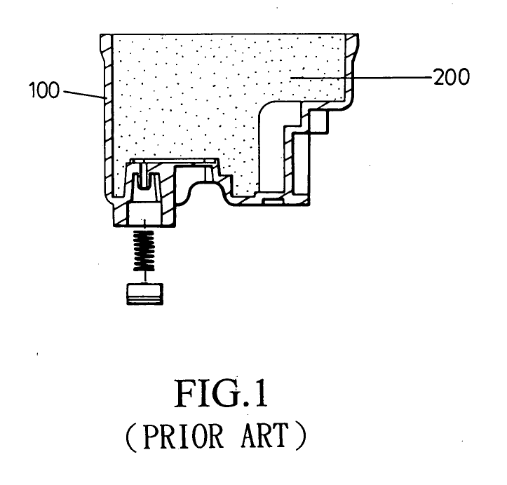

### DETAILED DESCRIPTION OF THE PREFERRED EMBODIMENTS

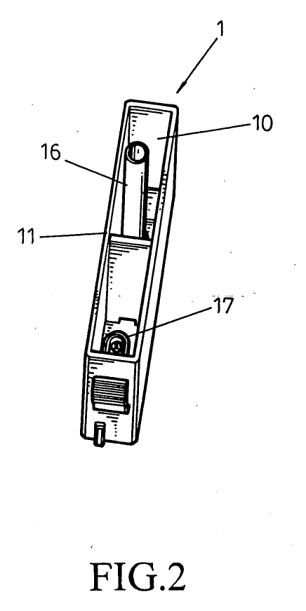

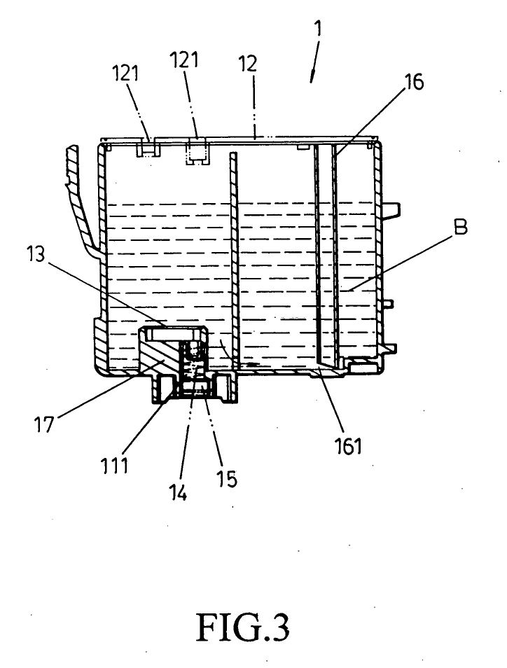

Referring to FIGS. 2 and 3, which show an ink cartridge 1 of the present invention assembled to primarily comprise a plastic case 11, a top cover 12, a strainer 13, a spring 14 and a rubber washer 15. The aforementioned structural elements are made from material that is resistant to deterioration from ink, and can be reused without affecting print quality of the ink cartridge 1. Wherein ink B is injected into a receptacle 10 of the ink cartridge 1 through ink inject holes 121 of the top cover 12 (upon injecting the ink B, the ink inject hole inks 121 are re-sealed). The strainer 13 is configured in a bottom of the receptacle 10, and a groove 111 below the strainer 13 provides for configuring the spring 14 and the rubber washer 15 therein, as well as connecting to a nozzle area of the printer. The present invention is characterized in that:

A siphon 16 is configured within the receptacle 10 of the Ink cartridge 1, an inclined opening 161 of a lower extremity of the siphon 16 realizes a mutual passage with the receptacle 10 and provides for ink B within the receptacle 10 to enter the siphon 16 therein, while an upper extremity of the siphon 16 realizes a mutual passage with air external to the ink cartridge 1. Referring to FIG. 3, which shows that when ink level of the ink B within the receptacle 10 is higher than level of the strainer 13, due to siphon principle, leakage of the ink B from the rubber washer 15 of the ink cartridge I in contact with the nozzle area is prevented. Furthermore, the ink B will not spill from the siphon 16. When the ink level of the ink B within the receptacle 10 is lower than the level of the strainer 13, the siphon principle does not come into effect. However, the strainer 13 is circumjacently configured with a plastic wall 17 that counterchecks the ink B from leaking out of the nozzle contact area, as well as preventing spillage of ink from the siphon 16.

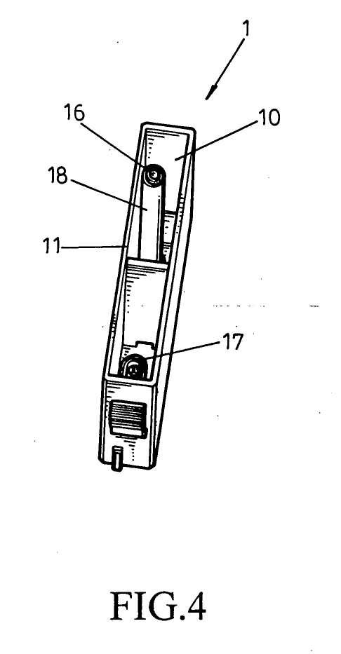

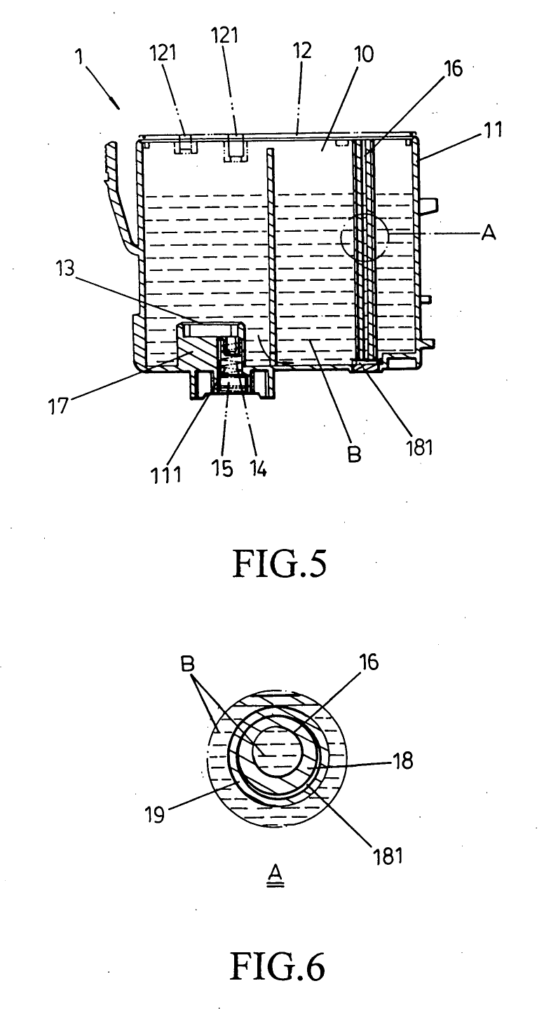

Referring to FIGS. 4, 5, and 6, which show the siphon 16 of the present invention can be additionally peripherally configured with an inner tube 18 and an outer tube 19. The inner tube 18 is so configured to be eccentric to the siphon 16, thereby resulting in an air hole 181 being formed between the inner tube 18 and the outer tube 19. The air hole 181, moreover, realizes a mutual passage with the siphon 16.

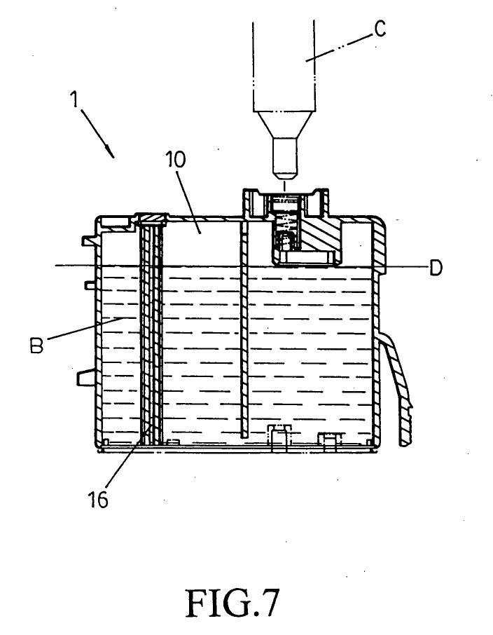

Referring to FIG. 7, which shows a method for refilling the ink B, whereby the ink cartridge 1 is first retrieved from the printer and placed upside down. An ink filling instrument C having a syringe shape is utilized to slowly inject the ink B into the receptacle 10 through an ink refill hole of the rubber washer 15 that contacts the nozzle, and the ink B is continually injected until the ink B approaches a refill line D, whereupon refilling is stopped, thus preventing the ink B from spilling out of the siphon 16. In addition, because the ink cartridge 1 is made from transparent plastic, therefore a user is able to clearly see the level of the filling ink, and thereby know when the ink B approaches the refill line D.

In conclusion, because the ink cartridge 1 of the present invention does not utilize any sponge as material for the ink cartridge 1, therefore the ink cartridge 1 can be refilled with an even greater quantity of ink B therein (by utilizing the volume otherwise taken up by the sponge within the conventional ink cartridge), thereby realizing the printing of an even greater number of sheets of paper from each usage of the ink cartridge 1. Furthermore, the ink cartridge 1 can be repeatedly refilled and reused without affecting quality of printing of the ink cartridge, and without causing problems in environmental protection recovery.

It is of course to be understood that the embodiments described herein is merely illustrative of the principles of the invention and that a wide variety of modifications thereto may be effected by persons skilled in the art without departing from the spirit and scope of the invention as set forth in the following claims.

1. An inkjet printer ink cartridge comprising a plastic case, a top cover, a strainer, a spring and a rubber washer, wherein ink can be injected into a receptacle of the ink cartridge through ink inject holes of the top cover; the strainer is configured in a bottom of the receptacle, and a groove below the strainer provides for configuring the spring and the rubber washer therein, as well as connecting to a nozzle area of the printer; and is characterized in that:
a siphon is configured within the receptacle of the Ink cartridge, and an opening of a lower extremity of the siphon realizes a mutual passage with the receptacle, while an upper extremity of the siphon realizes a mutual passage with air external to the ink cartridge; due to a siphon principle, leakage of the ink from area of the ink cartridge in contact with the nozzle area is prevented, furthermore, the ink is prevented from spilling from the siphon.

2. The inkjet printer ink cartridge according to claim 1, wherein the strainer is circumjacently configured with a plastic wall, such that when ink level of the ink within the receptacle is lower than level of the strainer, the plastic wall counterchecks the ink from leaking out.

3. The inkjet printer ink cartridge according to claim 1, wherein the siphon can be additionally peripherally configured with an inner tube and an outer tube, whereby an air hole is formed between the inner tube and the outer tube, and the air hole realizes a mutual passage with the siphon.

4. The inkjet printer ink cartridge according to claim 1, wherein the receptacle of the ink cartridge is not provided with sponge therein, and the ink is injected into the receptacle by means of an ink filling instrument, and continually injected until the ink approaches a refill line, whereupon refilling is stopped.
